(19) United States
(12) Patent Application Publication
(10) Pub. No.: US 2012/0239552 A1
(43) Pub. Date: Sep. 20, 2012

(54) SYSTEM AND METHOD FOR DYNAMIC WORKING CAPITAL

(76) Inventor: Edward A. Harycki, Bryn Mawr, PA (US)

(21) Appl. No.: 13/299,137

(22) Filed: Nov. 17, 2011

Related U.S. Application Data
(60) Provisional application No. 61/454,305, filed on Mar. 18, 2011.
(60) Provisional application No. 61/534,717, filed on Sep. 14, 2011.

(51) Int. Cl. G06Q 40/02

(52) U.S. Cl. 705/38; 705/39

(57) ABSTRACT

A method and system for dynamic working capital are disclosed. According to one embodiment, a computer-implemented method comprises calculating a maximum capital line available for a customer, providing for access by the customer to the maximum capital line, and providing for micro-repayment of funds received by the customer.

The present application claims the benefit of and priority to U.S. Provisional Application No. 61/454,305, entitled “DYNAMIC WORKING CAPITAL” filed on Mar. 18, 2011, and to U.S. Provisional Application No. 61/534,717, entitled “DYNAMIC WORKING CAPITAL” filed on Sep. 14, 2011, both of which are incorporated by reference herein in their entirety.

### FIELD

The present disclosure relates generally to computer systems and, more particularly, to a system and method for dynamic working capital.

### BACKGROUND

Access to sufficient working capital is one of the key drivers of success for small businesses. Small businesses (e.g. businesses with less than $10 million in annual revenue) rely on many different sources for working capital and financing (e.g. trade credit, factoring, bank lending and credit cards, governmental), most of which have become significantly more difficult for small business owners to obtain in a weakened economy. Due to the significant rise in the level and volatility of credit loss rates at most lenders serving the small business market since 2008, credit has become very tight. Many small businesses find it extremely difficult to obtain sufficient working capital or financing to operate their businesses. A key factor to reopening the markets for small business lending is the ability to control the level and volatility of credit losses.

### SUMMARY

A method and system for dynamic working capital are disclosed. According to one embodiment, a computer-implemented method comprises calculating a maximum capital line available for a customer, providing for access by the customer to the maximum capital line, and providing for micro-repayment of funds received by the customer.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

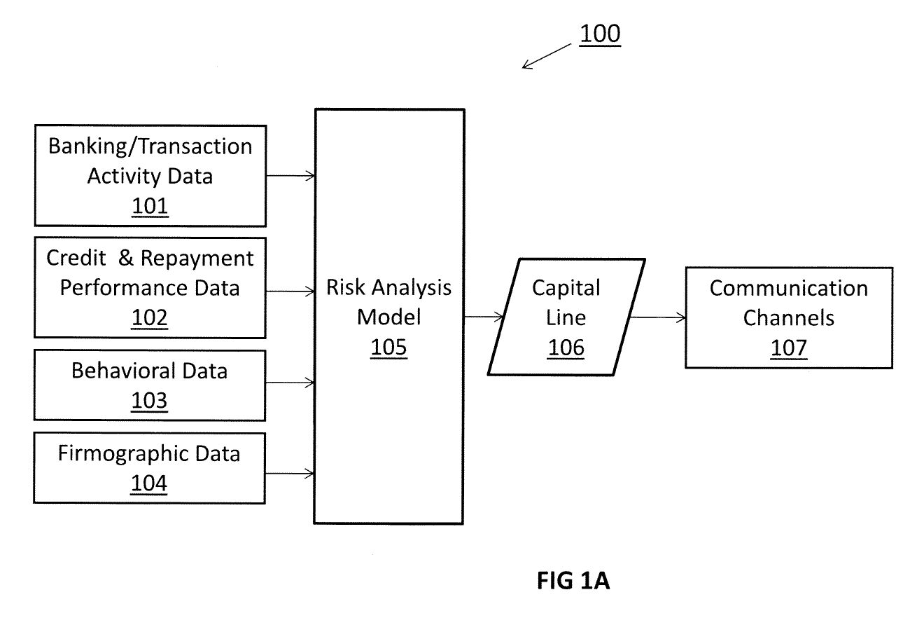

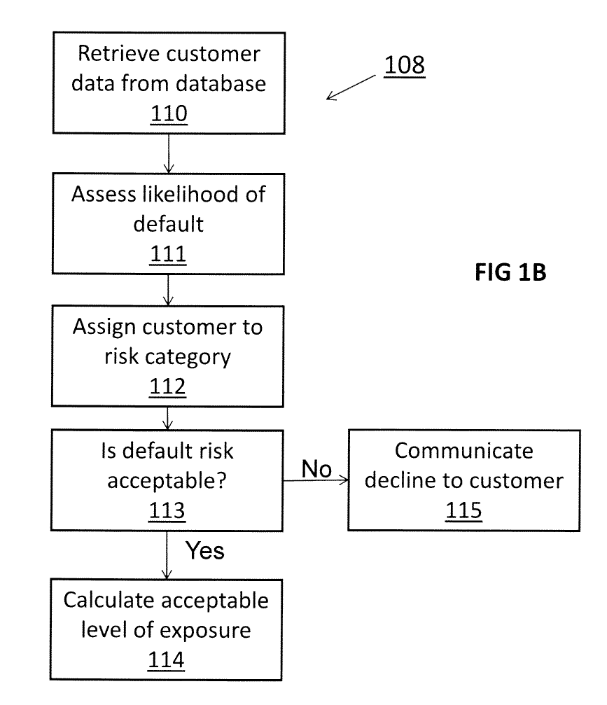

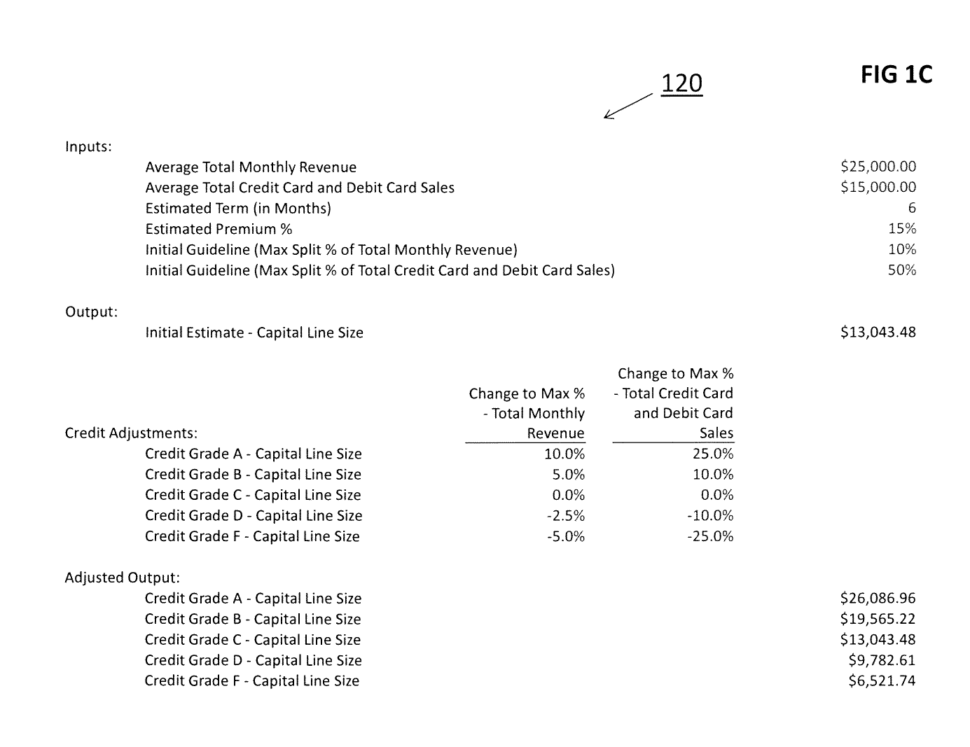

FIG. 1A illustrates an exemplary capital line assessment process for use with the present system, according to one embodiment.

FIG. 1B illustrates an exemplary capital line algorithm for use with the present system, according to one embodiment.

FIG. 1C illustrates an exemplary dynamic capital line assessment model example, according to one embodiment of the present system.

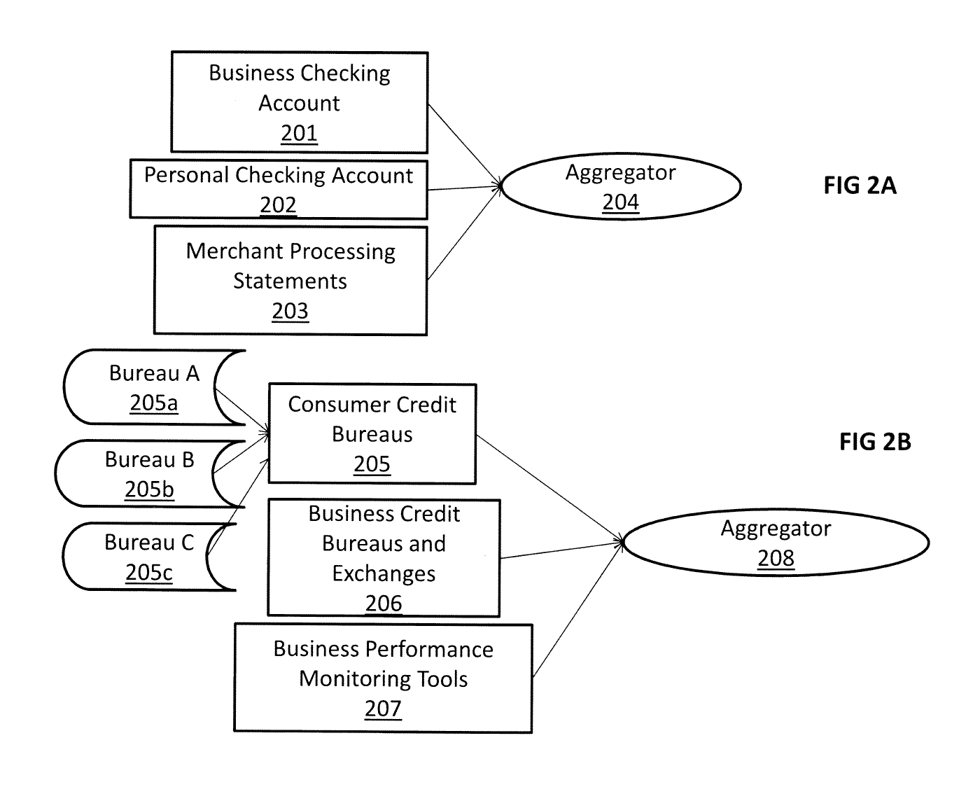

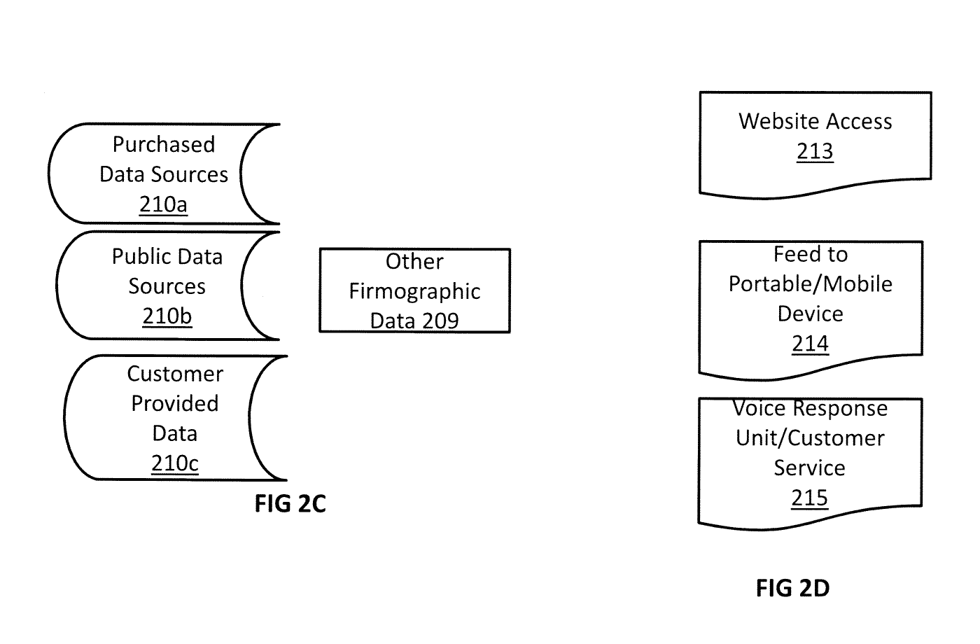

FIG. 2A illustrates exemplary banking and transaction activity data sources for use with the present system, according to one embodiment.

FIG. 2B illustrates exemplary credit and repayment performance data sources for use with the present system, according to one embodiment.

FIG. 2C illustrates exemplary firmographic data sources for use with the present system, according to one embodiment.

FIG. 2D illustrates exemplary communication channels for use with the present system, according to one embodiment.

FIG. 3 illustrates an exemplary capital delivery process for use with the present system, according to one embodiment.

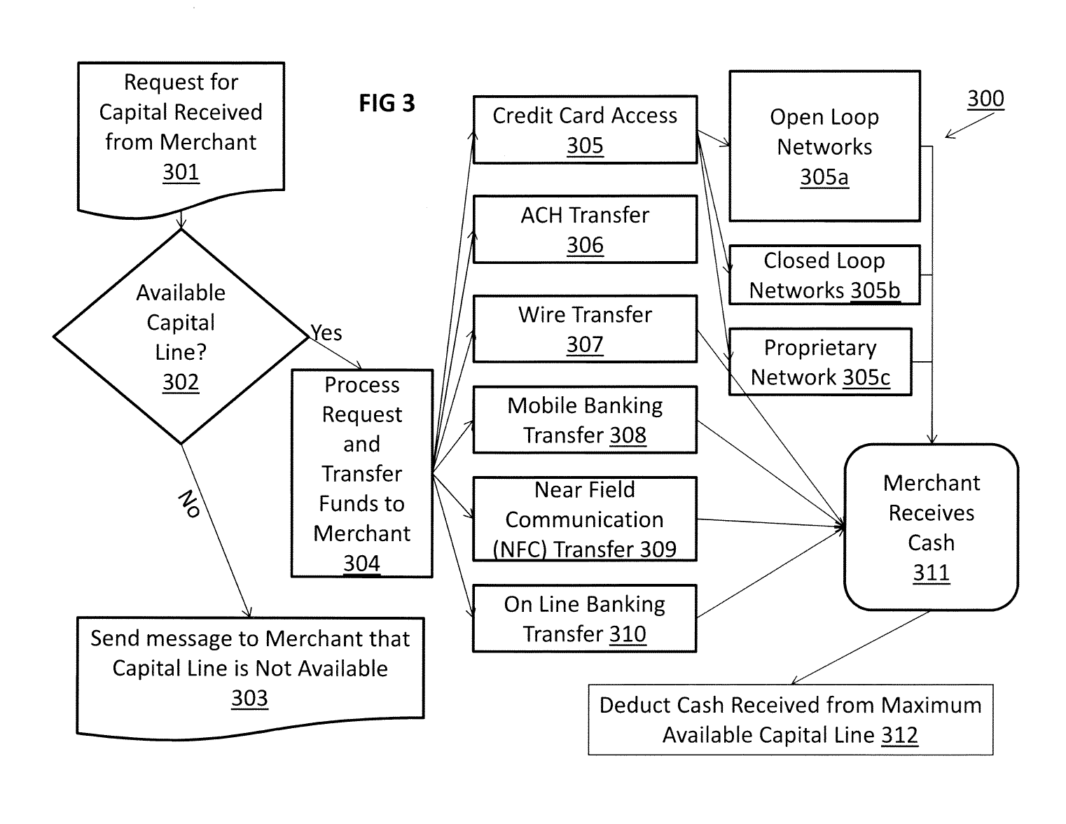

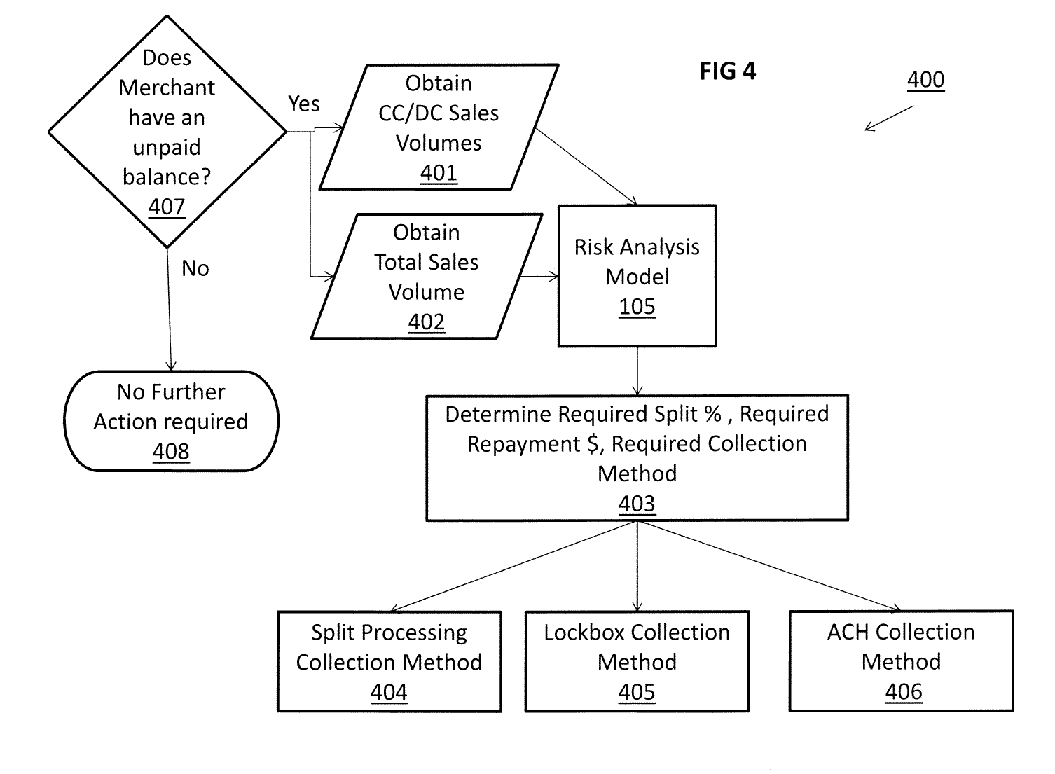

FIG. 4 illustrates an exemplary micro repayment process for use with the present system, according to one embodiment.

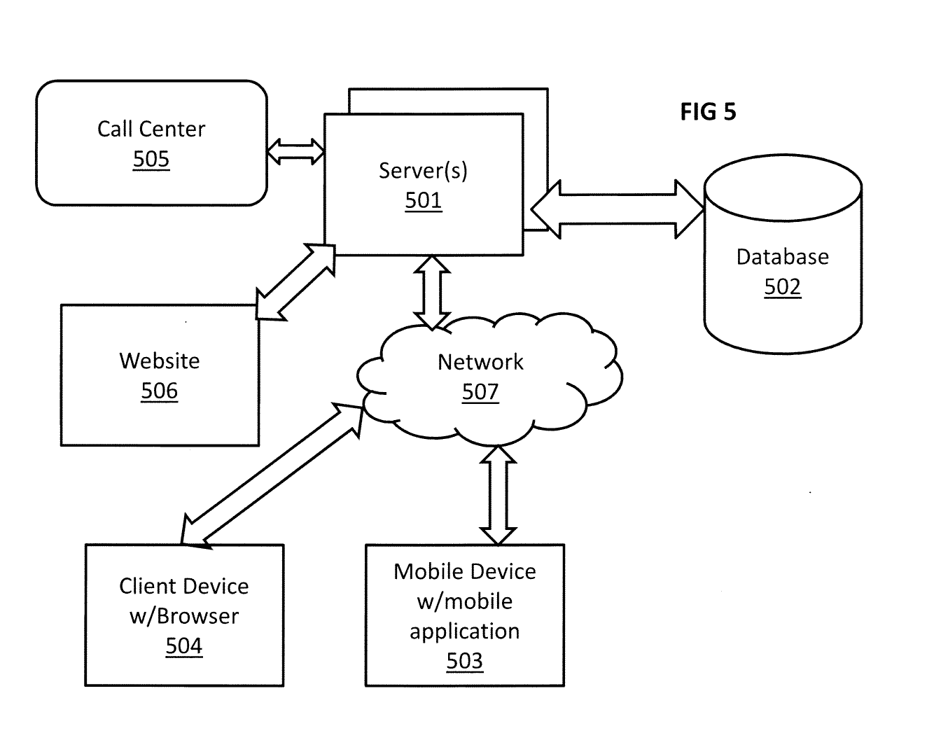

FIG. 5 illustrates an exemplary system level layout for use with the present system, according to one embodiment.

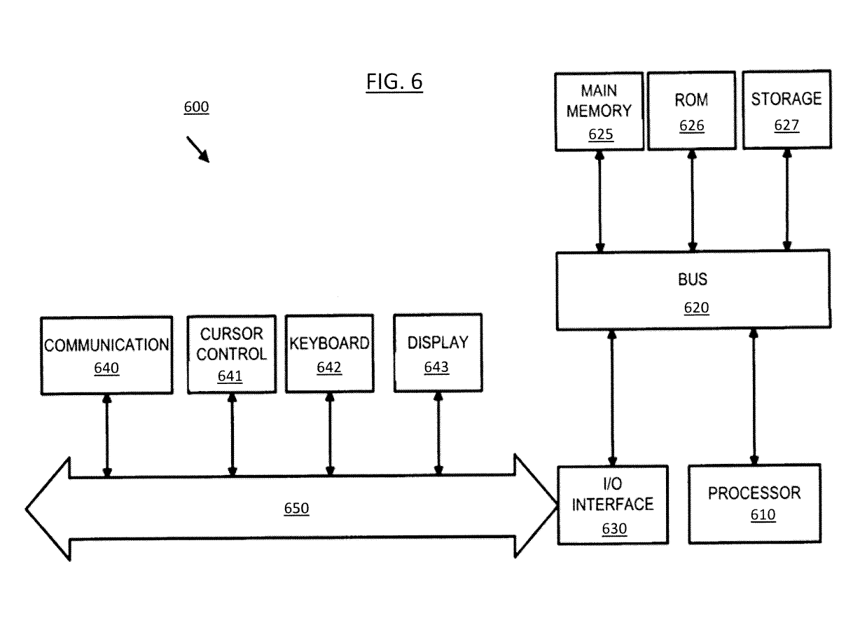

FIG. 6 illustrates an exemplary computer architecture for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

A method and system for dynamic working capital are disclosed. According to one embodiment, a computer-implemented method comprises calculating a maximum capital line available for a customer, providing for access by the customer to the maximum capital line, and providing for micro-repayment of funds received by the customer.

According to one embodiment, the present system merges micro repayment techniques with the utility and re-draw capabilities of revolving lines of credit and credit cards. The present system enables the creation of working capital products, including merchant cash advances and business cash advances, factoring, and loans, that incorporate the concept of a maximum draw amount or capital line (rather than a one-time draw) with automatic micro repayments (e.g. with a daily/weekly frequency) rather than monthly repayments, as is characterized by most bank lending and credit cards products.

According to one embodiment, the present system combines the convenience of a credit line found in credit cards and revolving lines of credit with a micro repayment process where repayment is obtained by direct access to a borrower's cash flows in a frequency that is either daily or weekly, rather than monthly as found in virtually all credit card and loan products.

According to one embodiment, the present dynamic working capital line system includes three components to ease the provision of credit to small businesses. The components include a capital line assessment, a capital delivery mechanism, and micro-repayment techniques.

It will be appreciated that customer is also referred to herein interchangeably as a merchant or business or small business.

Capital Line Assessment: The present system determines a maximum line amount (e.g. a capital line)—similar to the credit line feature found in credit cards and revolving lines of credit. The capital line is determined by analyzing any combination of business checking account information, personal checking account information, merchant credit card and debit card transactions, other frequent transactional information of the customer, information from consumer and commercial credit bureaus and exchanges, business performance monitoring tools from websites such as eBay, and Amazon or Facebook (or other companies that have various online means of ranking transactions and performance), information obtained directly from the customer and other firmographic information such as location, industry, and business type. The present system reviews several months of history of these accounts and transactional activity as well as the other information which impacts expected credit and repayment performance. The information, which is captured on a ‘real time’ basis, populates a risk analysis model which calculates the maximum capital line to be made available to the customer.

The present system performs an automated process to dynamically repopulate a risk analysis model to reset the capital line. This frequency of repopulation and recalculation may be daily, weekly, monthly, quarterly, annually, or event triggered. The capital line is managed and reset through automated processes residing on servers according to the present disclosure. The system communicates updated capital line values to customers through various channels that include on-line website access (through an online customer account portal), portable or mobile device applications or other alerts that may be sent directly to the customer's device of choice.

Capital Delivery Mechanism: Customers can access capital, up to the maximum capital line amount, through various methods, which include a credit card, by phone, online banking, mobile banking, the ACH network, wire transfer, and near field communication payment technology, according to one embodiment. Credit card access can be performed via a credit card issued by one of the leading networks (e.g. MasterCard™, VISA™, American Express™ Discover™, or other private label), through other open or closed loop networks, or through a proprietary network.

Micro-repayment: According to one embodiment, the present micro-repayment mechanism uses one of three processes: (a) a split funding mechanism available from merchant processors; (b) a direct debit mechanism; and (c) a split funding mechanism available from lockbox providers. It is noted that fixed repayment, variable repayment and blended repayment are used herein interchangeably.

The present system may be used with a number of applications. The present system enables its own merchant or business cash advance, credit card, loan and other working capital solutions. The present system may be offered directly to small businesses to cultivate, develop, and maintain a relationship directly with the small business. The present system can be offered to other third parties and financial institutions, and can be branded on behalf of the third party, or co-branded on behalf of the other third party and the provider.

FIG. 1A illustrates an exemplary capital line assessment process for use with the present system, according to one embodiment. A capital line assessment process 100 determines a maximum line amount (e.g. a capital line) similar to a credit line feature found in credit cards and revolving lines of credit. The capital line is determined by using a risk analysis model 105, according to one embodiment. The risk analysis model 105 resides on one or more of a plurality of dedicated servers and analyzes data from a variety of sources (101, 102, 103, 104) (some of which is received directly from customers) on a continuous basis to calculate a customized, customer-specific maximum capital line 106. It is noted that any data input to and utilized by the risk analysis model 105, according to one embodiment, can be provided by the customer.

Data for the risk analysis model 105 is captured from four types of sources, according to one embodiment. The sources include data related to the banking/transactional activity of the business and the business owner 101, data related to credit and repayment performance 102, behavioral data 103, and firmographic data 104. FIGS. 2A-2C include additional information regarding banking/transactional activity of the business and the business owner 101, data related to credit and repayment performance 102, and firmographic data 104.

Behavioral data 103 includes data from behavioral monitoring tools available from websites such as eBay, Amazon, and Facebook, (or any other companies that have various means of ranking transactions and performance). The behavioral data 103 is included in a risk analysis model 105 database. Behavioral data 103 from behavioral monitoring tools can be obtained directly using software provided by the suppliers of the tools, according to one embodiment. Non-limiting examples of behavioral data 103 obtained from behavioral monitoring tools include number, dollar amount and frequency of sales, customer satisfaction rankings, on line rankings, on-line preferences, online activity, frequency of searches, and frequency of visits to web sites. According to one embodiment, online activity or online ranking includes how others rank the business/customer (e.g. merchant reviews/rating on eBay) and how the business/customer ranks others (e.g. “likes” on Facebook).

According to one embodiment, capturing and updating data from data sources (in this example, 101-104) is performed on a ‘real time’ basis (or as frequently as permitted by the data sources and as frequently as is prudent from a cost/benefit perspective).

Once all of the initial information about a potential customer has been obtained, the risk analysis model 105 runs an algorithm according to the present disclosure (depicted in FIG. 1B) to determine the maximum capital line 106 which can be made available. Upon completion of the risk analysis model 105 algorithm, the model 105 calculates a maximum capital line available 106. This calculation can be repeated as frequently as the database receives updated information about the customer from the data sources. The automated process dynamically resets the maximum capital line available 106. The frequency of the repopulation and recalculation may be daily, weekly, monthly, quarterly, annually, or event driven. The maximum capital line available 106 is managed and reset continuously. It will be appreciated that collecting data for adjusting the maximum capital line and repopulating/recalculating the maximum capital line do not necessarily need to happen at the same frequency. For example, receiving updated information can occur on a daily basis, while the repopulation/recalculation might occur every other day, according to one embodiment.

The initial and updated maximum capital line available 106 is communicated to customers through a variety of channels 107. It is expected that the initial communication may be a customer service representative making a direct phone call to the customer. However, subsequent communications will be dictated by the channel preferences of the customer 107.

FIG. 1B illustrates an exemplary capital line algorithm 108 for use with the present system, according to one embodiment. The risk analysis model 105 retrieves all available information for the potential customer in the database 110. The business's likelihood of default over a specific period of time is assessed 111, and the potential customer is assigned to a risk category 112 which may be calculated in deciles, letter grades, or numerical grades, according to one embodiment. If the business's default risk is acceptable 113, an acceptable level of exposure is calculated 114 based on the potential customer's total average monthly business revenue, total average monthly credit card and debit card sales, the estimated acceptable repayment term, estimated premiums that will be charged, credit policy limits on split percentages, the potential customer's risk category and other characteristics known to be determinative of default risk. The risk categories can impact or limit a potential customer's acceptable split percentages, premiums, and estimated term. If the business' default risk is not acceptable 113, a decline notification is sent to the customer 115.

FIG. 1C illustrates an exemplary dynamic capital line assessment model example 120, according to one embodiment of the present system.

FIG. 2A illustrates exemplary banking and transaction activity data sources for use with the present system, according to one embodiment. The banking/transactional activity of the business and the business owner is obtained from three types of sources, as an example. Potential customers provide their business checking account activity 201 in one of several ways: via fax, via e-mail, through providing direct access to their on-line banking portal, or through an aggregator 204 which automates the access to their on-line banking portal. Depending on the manner in which the information is provided, manual entry may be required to input the data into the risk analysis model 105 database. If an aggregator 204 is used, the data may flow in an automated manner into the risk analysis model 105 database. Depending on the characteristics of the business, the requested term and size of the capital line, the risk analysis model 105 may require as many as twelve months of business checking account activity. Information obtained from the business checking account activity may include total business revenue, total credit card and debit card sales, certain expense disbursements, number and amount of NSF activity. Personal checking account activity 202 is handled in the same manner as the business checking account activity 201. As many as twelve months of activity may be required, according to one embodiment. Information obtained from personal checking account activity may include transfers to and from business bank accounts, number and amount of NSF's. Merchant processing statements 203 contain information about the amount of a business's products and services that are purchased by customers using credit and debit cards. Every business that accepts credit cards and debit cards to complete sales has an arrangement with at least one merchant processor. Each merchant processor produces a monthly statement detailing the business's activity for the period. Potential customers provide their merchant processing statements in the same manner as the business checking account activity and the personal checking account activity. Information may be obtained through an aggregator which may be the same or different than the aggregator 204 used to automate the extraction of business checking account and personal checking account information. Information obtained from the merchant processing statements 203 may include total card processing volume, number of transactions, number of batches submitted each month, number and amount of charge-backs.

FIG. 2B illustrates exemplary credit and repayment performance data sources for use with the present system, according to one embodiment. Credit and repayment performance information is obtained from three types of sources, including Consumer credit bureaus 205, business credit bureaus and exchanges 206 and other business performance monitoring tools 207. Currently, there are three main consumer credit bureau reporting entities in the US (205a, 205b, 205c). Consumer credit bureau information is obtainable according to the present system for each business owner or guarantor that signs an application. Information from the consumer credit bureaus 205 can be obtained directly using software provided by the consumer credit bureaus 205 or through an aggregator 208 that has arrangements with any and all of the consumer credit bureaus to automate the extraction and transfer of the consumer bureau information into the risk analysis model 105 database. If the consumer credit bureau information is obtained directly, manual input may be required to transfer the information into the risk analysis model 105 database. Examples of information that may be obtained from consumer credit bureaus include FICO scores (or their equivalent), level and amount of revolving trade activity, recent inquiries, recent delinquency performance with other credit sources. Information from business credit bureaus and exchanges 206 is also used to populate the risk analysis model 105 database. Information from the business credit bureaus and exchanges 206 can be obtained directly using software provided by the business credit bureaus and exchanges 206. Examples of information obtained from business credit bureaus and exchanges 206 include business credit scores, recent delinquency performance with other credit sources. Information from business performance monitoring tools 207 is also used to populate the risk analysis model 105 database. Business performance monitoring tools are the types of reports used to understand the credit risk of businesses but which are not typically provided by business credit bureaus or exchanges. Information from business performance monitoring tools 207 can be obtained directly using software provided by the suppliers of the tools. Examples of information obtained from business performance monitoring tools 207 include trade line performance, payments on utility bills, payments on leases/rent payments, and level and number of mobile device payments. According to one embodiment, obtaining information about a customer's repayment behaviors from any and all of the data sources noted above is provided for.

Once a customer has received a capital line assessment 106, the customer/merchant agrees to contract terms according to the present system. The contract terms may include some or all of the following: the purchase price for future receivables, the amount of future receivables being sold, the daily percentage of future receivables that will be remitted to the provider of the capital line, the daily fixed amount that will be remitted to the provider of the capital line, the amount and timing of any premiums and fees, the frequency with which the capital line will be reset, a description of the events of default under the contract, the consequences and remedies if a default occurs, the circumstances under which a merchant is personally liable, the preferred collection method, the available capital delivery mechanisms, authorizations to file UCCs, authorizations to access personal and business credit information, authorization to access personal and business transactional activity, and other commercially standard contract provisions.

FIG. 2C illustrates exemplary firmographic data sources for use with the present system, according to one embodiment. Firmographic data comes from two or more types of sources, as an example, including purchased data sources 210a, public data sources 210b and customer provided data sources 210c. Purchased data sources 210a include information about a business's industry type, estimated sales volume, number of employees, and e-mail address. Public data sources 210b includes information about a business's physical location, mailing address, telephone number, filings with the Secretary of State for their state, lawsuits outstanding, and liens filed against the business. Customer provided data sources 210c include information provided on an application or through other verbal or written communication with a customer, as an example. According to one embodiment, firmographic data can also include data from other firmographic data sources 209. In some cases, information from both purchased and public data sources is obtainable in electronic formats which allows for automated population of the risk analysis model 105 database. In other cases, the information is manually input. In some cases, customer provided data sources 210c is obtained in electronic format which allows for automated population of the risk analysis model 105 database. In other cases, the information is manually input.

FIG. 2D illustrates exemplary communication channels for use with the present system, according to one embodiment. Exemplary communication channels include on-line website access (through an on-line customer portal) 213, portable or mobile device applications or other alerts that may be sent directly to the customer's device of choice, such as e-mail alerts, text alerts, etc. 214, and by the customer having access to a voice response unit or a customer service representative 215.

FIG. 3 illustrates an exemplary capital delivery mechanism for use with the present system, according to one embodiment. Once the risk analysis model 105 has calculated the maximum capital line available 106 and communicated the amount to a customer through the customer's preferred communication channel 107, the customer (also referred to herein interchangeably as a merchant or business or small business) can request access to the capital line as needed. Included in the request for capital is a request that the capital be delivered in a certain manner. The request for capital can be received 301 from the customer in a variety of ways including from a website 213, from a mobile device 214, or from a call into a customer service function 215. In a further embodiment, the request for capital may be received 301 from a credit card processing network 305, a mobile banking app 308, or a near field communication device 309, or some similar mechanisms. In all cases, the request for capital is checked against the remaining availability 302 of the maximum capital line available 106. If the dollar amount of the request for capital exceeds the remaining availability on the maximum capital line available 106, a message is sent to the customer that the request for capital has been partially or completely denied 303. The message can be sent via the customer's preferred communication channel 107. If the dollar amount of the request for capital is less than the remaining availability on the maximum capital line 106, the request is processed and the funds are transferred in the manner requested by the customer 304.

Funds are transferred (and capital delivered) in a manner requested by the customer. According to one embodiment, six different delivery mechanisms are available. The delivery mechanisms include a credit card processing network 305, ACH transfer 306, wire transfer 307, mobile banking app transfer 308, near field communication device transfer 309, and other on-line banking transfers 310.

An ACH transfer 306 involves the use of the Automated Clearing House, an electronic network for financial transactions in the U.S. To complete a delivery of capital 304 via an ACH transfer 306, the customer provides their business checking account information and bank routing information, as an example. An ACH transfer is governed by rules established by NACHA and the Federal Reserve. The present system includes an arrangement with a U.S. financial institution which provides access to the ACH network, according to one embodiment.

A wire transfer 307 involves the use of wire transfer services provided by a U.S. financial institution. To complete a delivery of capital 304 via a wire transfer 307, the customer provides their business checking account information and bank routing information, along with information about the address of the business and the bank. The present system includes an arrangement with a U.S. financial institution which provides access to wire transfer services. A wire transfer is governed by the rules of the U.S. financial institution providing the wire transfer services and the Federal Reserve.

The delivery of capital 304 via a credit card processing network 305 involves an arrangement with a provider of credit cards that access open loop networks 305a such as MasterCard™, Visa™, American Express™, Discover™, or other similar networks, closed loop networks 305b, or in a further embodiment, a proprietary network 305c. In all cases, a customer is provided with a credit card (or similar device) for accessing the credit card processing network 305. A customer presents their card for use at a business that accepts, for payment, the cards issued by such credit card processing network 305. The credit card processing network 305 checks the maximum capital line available 106 and, if appropriate, allows the customer to obtain capital to complete a purchase. Through the network settlement process, the credit card processing network 305 funds the purchase and gets reimbursement from the provider of the maximum capital line available 106.

The present system also includes three other mechanisms used for the delivery of capital 304: mobile banking transfers 308, near field communication transfers 309 and on line banking transfers 310. In each of these cases, alternative payment systems are accessed in a manner similar to the manner described for the credit card processing networks. A device is used to request capital line availability and confirm that the payment system can facilitate the completion of a transaction. The payment system subsequently gets reimbursement for the transaction from the provider of the maximum capital line available 106. Given the pace of evolution of alternative payment systems such as PayPal™ and alternative currencies such as BitCoin™, it is understood that any payment mechanism can be included in further embodiments without departing from the scope of the present disclosure.

Once a request for a delivery of capital 304 has been fulfilled 311, either by transferring funds to a bank account designated by the customer or by the use of the funds to complete a transaction as directed by a customer, information about the dollar amounts involved is captured in the database and servicing platform and are deducted from the availability of maximum capital line available 312. Other than availability, the present embodiment does not include any restrictions on the frequency of accessing the maximum capital line available 106. However, in another embodiment, access can be restricted based on a customer's risk category, expected use of the funds, fraud risk assessments, or costs of the delivery mechanism.

FIG. 4 illustrates an exemplary micro repayment process for use with the present system, according to one embodiment. The exemplary micro repayment mechanism is based on requiring repayments in small amounts, and on a frequent basis, because the scenario is beneficial for both customers and the providers of the dynamic capital line. The customer benefits because the micro repayment mechanism is tied to the cash flows of the business and fluctuates as the customer's business activity fluctuates. The provider of the dynamic capital line benefits because repayments happen quickly and are less likely to be subject to long term credit risk.

The micro repayment process 400 determines whether the customer's maximum capital line has an outstanding balance 407. If there is a balance, the customer's recent credit card and debit card sales volume are obtained 401 and the customer's recent total sales volume is obtained 402. This information may be obtained from the same aggregator used in the capital line assessment process 100 or a different aggregator. According to one embodiment, at least some of the information is collected daily. The information is input into the risk analysis model 105 database either using an automated process or a manual process, depending on the source of the information. If there is no balance outstanding 407, there is no requirement to initiate the micro repayment mechanism 408. However, in another embodiment, the information about the customer's credit card, debit card and total sales volume is collected regardless of whether an unpaid balance exists.

According to one embodiment, the present micro repayment process 400 includes (a) a split funding mechanism available from merchant processors, whereby a portion of the customers' credit and debit card sales are split and diverted to the provider of the capital line, based upon pre-agreed terms 404, (b) a direct debit mechanism whereby the provider of the capital line uses information gathered from merchant processors and other sources, including aggregators, about a customer's credit and debit card sales and total sales volume to create a payment request (typically an ACH debit through the NACHA system), based upon pre-agreed terms 406; and (c) a split funding mechanism available from lockbox providers whereby all of a customers' credit card and debit card sales receipts (or all receipts) are deposited into a bank account and subsequently a portion is diverted to the provider based upon pre-agreed terms 405. In another embodiment, additional processes are available including PayPal.

Pre-agreed terms (according to a contract agreement with the customer) include the payment factor or split percentage. The payment factor or split percentage can be calculated according to various methods. The split percentage is assessed so that amounts accessed under the capital line are repaid over an estimated period of time (for example, over 90 days—although this process does not set a fixed maturity or payoff date). According to another embodiment, the split takes the form of a fixed dollar amount payment rather than a %-based payment. In a further embodiment, the split is based on the customer's total business revenue rather than the customer's credit card and debit card sales. The repayment term and split percentage or split amount (whether a fixed amount or percentage or a variable amount or percentage) is determined 403 individually for each customer by the risk analysis model 105 (including some or all of the information used to determine the size of the capital line), the customer's repayment term preferences and the advance amount (including the amount drawn and a premium and fees).

According to one embodiment, a necessary split percentage (or amount) is also calculated that ensures advance amounts plus any and all premiums and fees charged will be repaid over the targeted or estimated repayment timeframe 403. Repayment calculations are based upon either a full draw of the capital line, or on a utilization-based approach, where the repayment calculation takes into account the percentage utilization of the capital line. In all such cases, incremental advances do not have the effect of extending the expected repayment period for the initial or prior advance. Repayment amounts are applied to the oldest advance (and its associated premiums and fees) first.

For example, in a fixed daily payment amount, if a customer had a maximum capital line available of $2,786 and an expected repayment term of 90 days on all advances, as soon as a customer uses one of the capital delivery mechanisms to obtain capital, a fixed repayment amount of $30.96 ($2,786 divided by 90 days) is collected using the collection method dictated for that customer by the risk analysis model 105. The fixed daily repayment amount is applied to the cumulative amount of advances (and associated premiums and fees) outstanding.

A second example involves using a fixed split percentage of a customer's credit card and debit card sales volume to calculate the daily repayment amount. This involves the same fixed split percentage used to calculate the maximum capital line available. In this example, as soon as a customer uses one of the capital delivery mechanisms to obtain capital, the customer's credit card and debit card sales activity for the day is obtained and the daily repayment amount is calculated by taking the fixed split percentage of the day's credit card and debit card sales activity to create a variable repayment amount. Similar to the first example, the variable repayment amount is applied to the cumulative amount of advances (and associated premiums and fees) outstanding. In a further embodiment, the fixed split percentage used for calculating the variable repayment amount can be different than the fixed split percentage used to calculate the maximum capital line available or the fixed split percentage can be applied to the customer's total revenues, or some combination of each variation. In both of the product examples above, the amount of time required to repay the balance outstanding on the capital line will never exceed an expected term as agreed to in the contract with a customer, but will vary based on the percentage of the maximum available capital line being utilized. The amounts outstanding are only paid in full by the expected term if the customer stops using the capital line or access to the line is terminated by the provider of the capital line.

A third example involves calculating the split percentage based on a ratio of the amount of capital advanced to the maximum capital line available. In this case, a variable split percentage is created by multiplying the fixed split percentage used to calculate the maximum capital line available by the ratio of the amount of capital advanced to the maximum capital line available. This variable split percentage is reset only if additional amounts are advanced, not when repayment amounts are applied. The variable split percentage is used to calculate a variable repayment amount based off the customer's daily credit card and debit card sales activity (or, in a further embodiment, a customer's daily total sales volume). In this product example, the amount of time required to repay the balance outstanding on the capital line approximates an expected term as agreed to in the contract with a customer. The amounts outstanding are only paid in full by the expected term if the customer stops using the capital line or access to the line is terminated by the provider.

A fourth example involves using a stacked approach to applying repayment amounts. In this example, each repayment amount (whether calculated as a fixed repayment amount or a variable repayment amount based off of a fixed or variable percentage of a customer's credit card and debit card sales volume (or total sales volume)) is applied to the oldest advance (and its associated premiums and fees) first until that advance is paid in full. This approach to applying repayment amounts ensures that the balance from any one specific advance is repaid within an estimated repayment term.

In all four product examples, the calculated split percentage may be adjusted whenever the maximum capital line available is reset, an advance is made, or an advance is fully repaid. Table 1 below provides an exemplary overview of the examples described above.

According to one embodiment, repayment amounts are collected at various frequencies such as daily, weekly or monthly. The repayments are obtained through merchant split processing 404, via ACH 406, through utilization of a lockbox account where the split is performed 405, or through other payment mechanisms that permit daily/weekly micro repayments. The risk analysis model 105 determines which collection method needs to be utilized for an individual customer and the frequency of obtaining the repayment amounts.

TABLE 1
Product Examples

| Product Example | Blended Repayment | Stacked Advances |
|---|---|---|
| Type of Products | Merchant or business cash | Merchant or business cash |
| | advance, credit card loan, | advance, credit card loan, |
| | revolving line of credit, | revolving line of credit, |
| | installment loan, factoring | installment loan, factoring |
| Capital Delivery | | |
| Mechanism | | |
| How is Capital Line | Wire, Check, Mobile App, | Wire, Check, Mobile App, |
| Accessed? | ACH, phone, NFC technology, | ACH, phone, NFC technology, |
| | Card | Card |
| Frequency of Access | Multiple - within max Line Size | Multiple - within max Line Size |
| Capital Line | | |
| Assignment Algorithm | | |
| Underwriting “UW” | Customer input information, | Customer input information, |
| Information Sources | Customer business operating | Customer business operating |
| | information (which may | information (which may |
| | include information extracted | include information extracted |
| | daily from bank, credit card | daily from bank, credit card |
| | processing or other merchant | processing or other merchant |
| | statements), information from | statements), information from |
| | credit bureaus and exchanges | credit bureaus and exchanges |
| | (personal and business), | (personal and business), |
| | information from business | information from business |
| | performance monitoring tools | performance monitoring tools |
| | from websites such as eBay, | from websites such as eBay, |
| | Amazon or Facebook (or other | Amazon or Facebook (or other |
| | companies that have various | companies that have various |
| | online means of ranking | online means of ranking |
| | transactions and | transactions and |
| | performance), other | performance), other |
| | firmographic information | firmographic information |
| | (which may include | (which may include |
| | demographic, geographic, | demographic, geographic, |
| | industry, business type | industry, business type |
| | information) | information) |
| Capital Line | Automatic calculations on | Automatic calculations on |
| Assessment | servers, at agreed | servers, at agreed |
| Methodology | frequencies, based on data | frequencies, based on data |
| | captured or obtained. | captured or obtained. |
| Capital Line | Automatic - reset daily, | Automatic - reset daily, |
| Adjustment Frequency | weekly, monthly, quarterly, | weekly, monthly, quarterly, |
| | annually | annually |
| Notification Methods - | SMS texts, apps, e-mail, | SMS texts, apps, e-mail, |
| Push | phone | phone |
| Notification Methods - | apps, on line banking, VRU, | apps, on line banking, VRU, |
| Self Service | SMS Texts | SMS Texts |
| Micro Repayment | | |
| Mechanism | | |
| Payment Factor | Fixed % or Fixed $, based | Floating % or Floating $, |
| | on UW and Line Size | based on UW, Line Size and |
| | | Utilization %, subject to a |
| | | maximum % or maximum $ |
| Repayment | (a)—merchant processing | (a)—merchant processing |
| Mechanisms | split-funding: %-based | split-funding: %-based |
| | (estimated maturity) | (estimated maturity) |
| | (b)—merchant processing | (b)—merchant processing |
| | split-funding (which may | split-funding (which may |
| | include an intermediate step | include an intermediate step |
| | such as a lock box): fixed | such as a lock box): fixed |
| | dollar amount (targeted | dollar amount (targeted |
| | maturity) | maturity) |
| | (c)—daily ACH: %-based | (c)—daily ACH: %-based |
| | (estimated maturity) | (estimated maturity) |
| | (d)—daily ACH: fixed dollar | (d)—daily ACH: fixed dollar |
| | amount (targeted maturity) | amount (targeted maturity) |
| | (e)—other daily payment | (e)—other daily payment |
| | mechanisms such as Paypal, | mechanisms such as Paypal, |
| | etc. | etc. |
| When is Payment | When Capital Line Size is | (A) Immediately after a new |
| Factor Adjusted? | reset to ensure an | advance (based on utilization |
| | estimated/targeted maturity | %), (B) immediately after an |
| | | advance is repaid and (C) |
| | | when Capital Line Size is reset |
| How Are Payments | Against aggregate advances | Against oldest advance (with |
| Applied? | plus premium and fees | its associated premium and |
| | | fees) until individual advances |
| | | plus premium and fees are |
| | | repaid in full |

FIG. 5 illustrates an exemplary system level layout for use with the present system, according to one embodiment. A server (or plurality of servers) having software according to the present disclosure 501 is in communication with a network 507 and a database 502. It is understood that the database 502 may be a separate entity from the server 501 or plurality of servers, or the database 502 may reside on the server 501 or plurality of servers without departing from the scope of the present disclosure. Included in the server 501 or plurality of servers is a web server, for hosting a website 506 accessible by any client computing device having a browser 504 in communication over the network 507. A mobile device having a mobile application 503 for use with the present system is also in communication with the network 507 in order to provide necessary information to the server 501. A call center 505 provides another avenue for a customer to provide information to the server 501.

FIG. 6 illustrates an exemplary computer architecture for use with the present system, according to one embodiment. One embodiment of architecture 600 comprises a system bus 620 for communicating information, and a processor 610 coupled to bus 620 for processing information. Architecture 600 further comprises a random access memory (RAM) or other dynamic storage device 625 (referred to herein as main memory), coupled to bus 620 for storing information and instructions to be executed by processor 610. Main memory 625 also may be used for storing temporary variables or other intermediate information during execution of instructions by processor 610. Architecture 600 also may include a read only memory (ROM) and/or other static storage device 626 coupled to bus 620 for storing static information and instructions used by processor 610.

A data storage device 627 such as a magnetic disk or optical disc and its corresponding drive may also be coupled to computer system 600 for storing information and instructions. Architecture 600 can also be coupled to a second I/O bus 650 via an I/O interface 630. A plurality of I/O devices may be coupled to I/O bus 650, including a display device 643, an input device (e.g., an alphanumeric input device 642 and/or a cursor control device 641).

The communication device 640 allows for access to other computers (servers or clients) via a network. The communication device 640 may comprise one or more modems, network interface cards, wireless network interfaces or other well known interface devices, such as those used for coupling to Ethernet, token ring, or other types of networks.

Tables 2A-4B below illustrate exemplary product scenarios, according to various embodiments.

TABLE 2A
Product A1 Example
Product A1
5% Fixed Repayment - Fixed Daily Payment Amount

| Example Business Financials | | | | Capital Line and Payments Calculations | | | |
|---|---|---|---|---|---|---|---|
| | Monthly Card | Monthly Sales | Card Volume/ | | Capital Line | Capital Line | |
| Month | Volume | Volume - Total | Total Volume | Max Daily Split | (90 day term) | (180 day term) | Daily Payment |
| 1 | $18,574 | $42,598 | 43.6% | 5% | $2,786 | $5,572 | $30.96 |
| 2 | $19,845 | $44,665 | 44.4% | 5% | $2,977 | $5,954 | $33.08 |
| 3 | $16,548 | $43,265 | 38.2% | 5% | $2,482 | $4,964 | $27.58 |
| 4 | $17,265 | $48,792 | 35.4% | 5% | $2,590 | $5,180 | $28.78 |
| 5 | $19,563 | $45,124 | 43.4% | 5% | $2,934 | $5,869 | $32.61 |
| 6 | $18,754 | $43,551 | 43.1% | 5% | $2,813 | $5,626 | $31.26 |
| 7 | $18,201 | $46,953 | 38.8% | 5% | $2,730 | $5,460 | $30.34 |
| 8 | $18,995 | $42,455 | 44.7% | 5% | $2,849 | $5,699 | $31.66 |
| 9 | $16,598 | $41,302 | 40.2% | 5% | $2,490 | $4,979 | $27.66 |
| 10 | $18,465 | $39,782 | 46.4% | 5% | $2,770 | $5,540 | $30.78 |
| 11 | $17,223 | $47,630 | 36.2% | 5% | $2,583 | $5,167 | $28.71 |
| 12 | $19,432 | $50,124 | 38.8% | 5% | $2,915 | $5,830 | $32.39 |
| Total | $219,463 | $536,241 | 40.9% | | | | |

TABLE 2B
Product A1 Example (Cont'd)
One Month Transaction View

| | | | | | | | | | | | Projected |
|---|---|---|---|---|---|---|---|---|---|---|---|
| | | | | | | | | | | | Days to |
| | | | | | Total | Cumulative | | | | | Repay |
| | Daily Card | Transaction | RTR | Premium | Billed | Amount | | Daily | Capital | Available | (90 day |
| Day | Volume | Amount | % | Billed | Amount | Billed | Payment | Balance | Line | Capital | term) |
| 1 | $879 | $250 | 1.05 | $12.50 | $262.50 | $262.50 | $0.00 | $262.50 | $2,786 | $2,523.60 | 8 |
| 2 | $1,062 | $0 | 1.05 | $0.00 | $0.00 | $262.50 | $30.96 | $231.54 | $2,786 | $2,554.56 | 7 |
| 3 | $321 | $0 | 1.05 | $0.00 | $0.00 | $262.50 | $30.96 | $200.59 | $2,786 | $2,585.51 | 6 |
| 4 | $255 | $0 | 1.05 | $0.00 | $0.00 | $262.50 | $30.96 | $169.63 | $2,786 | $2,616.47 | 5 |
| 5 | $987 | $278 | 1.05 | $13.90 | $291.90 | $554.40 | $30.96 | $430.57 | $2,786 | $2,355.53 | 14 |
| 6 | $1,003 | $564 | 1.05 | $28.20 | $592.20 | $1,146.60 | $30.96 | $991.82 | $2,786 | $1,794.28 | 32 |
| 7 | $0 | $200 | 1.05 | $10.00 | $210.00 | $1,356.60 | $30.96 | $1,170.86 | $2,786 | $1,615.24 | 38 |
| 8 | $789 | $0 | 1.05 | $0.00 | $0.00 | $1,356.60 | $30.96 | $1,139.90 | $2,786 | $1,646.20 | 37 |
| 9 | $654 | $0 | 1.05 | $0.00 | $0.00 | $1,356.60 | $30.96 | $1,108.95 | $2,786 | $1,677.15 | 36 |
| 10 | $799 | $0 | 1.05 | $0.00 | $0.00 | $1,356.60 | $30.96 | $1,077.99 | $2,786 | $1,708.11 | 35 |
| 11 | $1,165 | $314 | 1.05 | $15.70 | $329.70 | $1,686.30 | $30.96 | $1,376.73 | $2,786 | $1,409.37 | 44 |
| 12 | $699 | $124 | 1.05 | $6.20 | $130.20 | $1,816.50 | $30.96 | $1,475.98 | $2,786 | $1,310.12 | 48 |
| 13 | $702 | $0 | 1.05 | $0.00 | $0.00 | $1,816.50 | $30.96 | $1,445.02 | $2,786 | $1,341.08 | 47 |
| 14 | $0 | $0 | 1.05 | $0.00 | $0.00 | $1,816.50 | $30.96 | $1,414.06 | $2,786 | $1,372.04 | 46 |
| 15 | $465 | $0 | 1.05 | $0.00 | $0.00 | $1,816.50 | $30.96 | $1,383.11 | $2,786 | $1,402.99 | 45 |
| 16 | $765 | $130 | 1.05 | $6.50 | $136.50 | $1,953.00 | $30.96 | $1,488.65 | $2,786 | $1,297.45 | 48 |
| 17 | $333 | $250 | 1.05 | $12.50 | $262.50 | $2,215.50 | $30.96 | $1,720.19 | $2,786 | $1,065.91 | 56 |
| 18 | $687 | $0 | 1.05 | $0.00 | $0.00 | $2,215.50 | $30.96 | $1,689.24 | $2,786 | $1,096.86 | 55 |
| 19 | $798 | $120 | 1.05 | $6.00 | $126.00 | $2,341.50 | $30.96 | $1,784.28 | $2,786 | $1,001.82 | 58 |
| 20 | $642 | $0 | 1.05 | $0.00 | $0.00 | $2,341.50 | $30.96 | $1,753.32 | $2,786 | $1,032.78 | 57 |
| 21 | $0 | $150 | 1.05 | $7.50 | $157.50 | $2,499.00 | $30.96 | $1,879.87 | $2,786 | $906.23 | 61 |
| 22 | $1,120 | $164 | 1.05 | $8.20 | $172.20 | $2,671.20 | $30.96 | $2,021.11 | $2,786 | $764.99 | 65 |
| 23 | $650 | $187 | 1.05 | $9.35 | $196.35 | $2,867.55 | $30.96 | $2,186.50 | $2,786 | $599.60 | 71 |
| 24 | $485 | $0 | 1.05 | $0.00 | $0.00 | $2,867.55 | $30.96 | $2,155.55 | $2,786 | $630.55 | 70 |
| 25 | $657 | $0 | 1.05 | $0.00 | $0.00 | $2,867.55 | $30.96 | $2,124.59 | $2,786 | $661.51 | 69 |
| 26 | $608 | $0 | 1.05 | $0.00 | $0.00 | $2,867.55 | $30.96 | $2,093.63 | $2,786 | $692.47 | 68 |
| 27 | $689 | $60 | 1.05 | $3.00 | $63.00 | $2,930.55 | $30.96 | $2,125.68 | $2,786 | $660.42 | 69 |
| 28 | $0 | $26 | 1.05 | $1.30 | $27.30 | $2,957.85 | $30.96 | $2,122.02 | $2,786 | $664.08 | 69 |
| 29 | $639 | $0 | 1.05 | $0.00 | $0.00 | $2,957.85 | $30.96 | $2,091.06 | $2,786 | $695.04 | 68 |
| 30 | $721 | $100 | 1.05 | $5.00 | $105.00 | $3,062.85 | $30.96 | $2,165.11 | $2,786 | $620.99 | 70 |
| | $18,574 | $2,917 | | $146 | $3,063 | | $897.74 | | | | |

TABLE 3A
Product A2 Example
Product A2
5% Fixed Repayment - Fixed Daily Split %/Variable Daily $ Amount

| Example Business Financials | | | | Capital Line and Payments Calculations | | | |
|---|---|---|---|---|---|---|---|
| | Monthly Card | Monthly Sales | Card Volume/ | | Capital Line | Capital Line | |
| Month | Volume | Volume - Total | Total Volume | Max Daily Split | (90 day term) | (180 day term) | Daily Payment |
| 1 | $18,574 | $42,598 | 43.6% | 5% | $2,786 | $5,572 | $30.96 |
| 2 | $19,845 | $44,665 | 44.4% | 5% | $2,977 | $5,954 | $33.08 |
| 3 | $16,548 | $43,265 | 38.2% | 5% | $2,482 | $4,964 | $27.58 |
| 4 | $17,265 | $48,792 | 35.4% | 5% | $2,590 | $5,180 | $28.78 |
| 5 | $19,563 | $45,124 | 43.4% | 5% | $2,934 | $5,869 | $32.61 |
| 6 | $18,754 | $43,551 | 43.1% | 5% | $2,813 | $5,626 | $31.26 |
| 7 | $18,201 | $46,953 | 38.8% | 5% | $2,730 | $5,460 | $30.34 |
| 8 | $18,995 | $42,455 | 44.7% | 5% | $2,849 | $5,699 | $31.66 |
| 9 | $16,598 | $41,302 | 40.2% | 5% | $2,490 | $4,979 | $27.66 |
| 10 | $18,465 | $39,782 | 46.4% | 5% | $2,770 | $5,540 | $30.78 |
| 11 | $17,223 | $47,630 | 36.2% | 5% | $2,583 | $5,167 | $28.71 |
| 12 | $19,432 | $50,124 | 38.8% | 5% | $2,915 | $5,830 | $32.39 |
| Total | $219,463 | $536,241 | 40.9% | | | | |

TABLE 3B
Product A2 Example (Cont'd)
One Month Transaction View

| | | | | | | | | | | | Projected |
|---|---|---|---|---|---|---|---|---|---|---|---|
| | | | | | | | | | | | Days to |
| | Daily | | | | Total | Cumulative | | | | | Repay |
| | Card | Transaction | | Premium | Billed | Amount | Payment | Daily | Capital | Available | (90 day |
| Day | Volume | Amount | RTR % | Billed | Amount | Billed | (5%) | Balance | Line | Capital | term) |
| 1 | $879 | $250 | 1.05 | $12.50 | $262.50 | $262.50 | — | $262.50 | $2,786 | $2,523.60 | 8 |
| 2 | $1,062 | $0 | 1.05 | $0.00 | $0.00 | $262.50 | $53.10 | $209.40 | $2,786 | $2,576.70 | 7 |
| 3 | $321 | $0 | 1.05 | $0.00 | $0.00 | $262.50 | $16.05 | $193.35 | $2,786 | $2,592.75 | 6 |
| 4 | $255 | $0 | 1.05 | $0.00 | $0.00 | $262.50 | $12.75 | $180.60 | $2,786 | $2,605.50 | 6 |
| 5 | $987 | $278 | 1.05 | $13.90 | $291.90 | $554.40 | $49.35 | $423.15 | $2,786 | $2,362.95 | 14 |
| 6 | $1,003 | $564 | 1.05 | $28.20 | $592.20 | $1,146.60 | $50.15 | $965.20 | $2,786 | $1,820.90 | 31 |
| 7 | $0 | $200 | 1.05 | $10.00 | $210.00 | $1,356.60 | $0.00 | $1,175.20 | $2,786 | $1,610.90 | 38 |
| 8 | $789 | $0 | 1.05 | $0.00 | $0.00 | $1,356.60 | $39.45 | $1,135.75 | $2,786 | $1,650.35 | 37 |
| 9 | $654 | $0 | 1.05 | $0.00 | $0.00 | $1,356.60 | $32.70 | $1,103.05 | $2,786 | $1,683.05 | 36 |
| 10 | $799 | $0 | 1.05 | $0.00 | $0.00 | $1,356.60 | $39.95 | $1,063.10 | $2,786 | $1,723.00 | 34 |
| 11 | $1,165 | $314 | 1.05 | $15.70 | $329.70 | $1,686.30 | $58.25 | $1,334.55 | $2,786 | $1,451.55 | 43 |
| 12 | $699 | $124 | 1.05 | $6.20 | $130.20 | $1,816.50 | $34.95 | $1,429.80 | $2,786 | $1,356.30 | 46 |
| 13 | $702 | $0 | 1.05 | $0.00 | $0.00 | $1,816.50 | $35.10 | $1,394.70 | $2,786 | $1,391.40 | 45 |
| 14 | $0 | $0 | 1.05 | $0.00 | $0.00 | $1,816.50 | $0.00 | $1,394.70 | $2,786 | $1,391.40 | 45 |
| 15 | $465 | $0 | 1.05 | $0.00 | $0.00 | $1,816.50 | $23.25 | $1,371.45 | $2,786 | $1,414.65 | 44 |
| 16 | $765 | $130 | 1.05 | $6.50 | $136.50 | $1,953.00 | $38.25 | $1,469.70 | $2,786 | $1,316.40 | 47 |
| 17 | $333 | $250 | 1.05 | $12.50 | $262.50 | $2,215.50 | $16.65 | $1,715.55 | $2,786 | $1,070.55 | 55 |
| 18 | $687 | $0 | 1.05 | $0.00 | $0.00 | $2,215.50 | $34.35 | $1,681.20 | $2,786 | $1,104.90 | 54 |
| 19 | $798 | $120 | 1.05 | $6.00 | $126.00 | $2,341.50 | $39.90 | $1,767.30 | $2,786 | $1,018.80 | 57 |
| 20 | $642 | $0 | 1.05 | $0.00 | $0.00 | $2,341.50 | $32.10 | $1,735.20 | $2,786 | $1,050.90 | 56 |
| 21 | $0 | $150 | 1.05 | $7.50 | $157.50 | $2,499.00 | $0.00 | $1,892.70 | $2,786 | $893.40 | 61 |
| 22 | $1,120 | $164 | 1.05 | $8.20 | $172.20 | $2,671.20 | $56.00 | $2,008.90 | $2,786 | $777.20 | 65 |
| 23 | $650 | $187 | 1.05 | $9.35 | $196.35 | $2,867.55 | $32.50 | $2,172.75 | $2,786 | $613.35 | 70 |
| 24 | $485 | $0 | 1.05 | $0.00 | $0.00 | $2,867.55 | $24.25 | $2,148.50 | $2,786 | $637.60 | 69 |
| 25 | $657 | $0 | 1.05 | $0.00 | $0.00 | $2,867.55 | $32.85 | $2,115.65 | $2,786 | $670.45 | 68 |
| 26 | $608 | $0 | 1.05 | $0.00 | $0.00 | $2,867.55 | $30.40 | $2,085.25 | $2,786 | $700.85 | 67 |
| 27 | $689 | $60 | 1.05 | $3.00 | $63.00 | $2,930.55 | $34.45 | $2,113.80 | $2,786 | $672.30 | 68 |
| 28 | $0 | $26 | 1.05 | $1.30 | $27.30 | $2,957.85 | $0.00 | $2,141.10 | $2,786 | $645.00 | 69 |
| 29 | $639 | $0 | 1.05 | $0.00 | $0.00 | $2,957.85 | $31.95 | $2,109.15 | $2,786 | $676.95 | 68 |
| 30 | $721 | $100 | 1.05 | $5.00 | $105.00 | $3,062.85 | $36.05 | $2,178.10 | $2,786 | $608.00 | 70 |
| | $18,574 | $2,917 | | $146 | $3,063 | | $884.75 | | | | |

TABLE 4A
Product B1 Example
Product B1
Stacked Advances - Daily Payment Based on % of Max Advance Utilized

| | | | | Capital Line and Payments Calculations | | | |
|---|---|---|---|---|---|---|---|
| Example Business Financials | | | | Card Based | Sales Based | | |
| | Monthly Card | Monthly Sales | Card Volume/ | Capital Line (90 | Capital Line | Actual Capital | Max Daily |
| Month | Volume | Volume - Total | Total Volume | day term) | (90 day term) | Line | Payment |
| 1 | $18,574 | $42,598 | 43.6% | $27,861 | $12,779 | $12,779 | $141.99 |
| 2 | $19,845 | $44,665 | 44.4% | $29,768 | $13,400 | $13,400 | $148.88 |
| 3 | $16,548 | $43,265 | 38.2% | $24,822 | $12,980 | $12,980 | $144.22 |
| 4 | $17,265 | $48,792 | 35.4% | $25,898 | $14,638 | $14,638 | $162.64 |
| 5 | $19,563 | $45,124 | 43.4% | $29,345 | $13,537 | $13,537 | $150.41 |
| 6 | $18,754 | $43,551 | 43.1% | $28,131 | $13,065 | $13,065 | $145.17 |
| 7 | $18,201 | $46,953 | 38.8% | $27,302 | $14,086 | $14,086 | $156.51 |
| 8 | $18,995 | $42,455 | 44.7% | $28,493 | $12,737 | $12,737 | $141.52 |
| 9 | $16,598 | $41,302 | 40.2% | $24,897 | $12,391 | $12,391 | $137.67 |
| 10 | $18,465 | $39,782 | 46.4% | $27,698 | $11,935 | $11,935 | $132.61 |
| 11 | $17,223 | $47,630 | 36.2% | $25,835 | $14,289 | $14,289 | $158.77 |
| 12 | $19,432 | $50,124 | 38.8% | $29,148 | $15,037 | $15,037 | $167.08 |
| Total | $219,463 | $536,241 | 40.9% | | | | |

TABLE 4B
Product B1 Example (Cont'd)
One Month Transaction View

| | | | | | | | | Bal- | Payment | | | Projected |
|---|---|---|---|---|---|---|---|---|---|---|---|---|
| | Trans- | | | Total | Cumulative | | | ance/ | Ratio | | | Days to |
| | action | RTR | Premium | Billed | Amount | | Daily | Capital | Calcu- | Capital | Available | Repay (90 |
| Day | Amount | % | Billed | Amount | Billed | Payment | Balance | Line | lation | Line | Capital | day term) |
| 1 | $2,500 | 1.12 | $300.00 | $2,800.00 | $2,800.00 | $0.00 | $2,800.00 | 21.9% | 21.9% | $12,779 | $9,979.40 | — |
| 2 | $0 | 1.12 | $0.00 | $0.00 | $2,800.00 | $31.11 | $2,768.89 | 21.7% | 21.9% | $12,779 | $10,010.51 | 89 |
| 3 | $0 | 1.12 | $0.00 | $0.00 | $2,800.00 | $31.11 | $2,737.78 | 21.4% | 21.9% | $12,779 | $10,041.62 | 88 |
| 4 | $0 | 1.12 | $0.00 | $0.00 | $2,800.00 | $31.11 | $2,706.67 | 21.2% | 21.9% | $12,779 | $10,072.73 | 87 |
| 5 | $0 | 1.12 | $0.00 | $0.00 | $2,800.00 | $31.11 | $2,675.56 | 20.9% | 21.9% | $12,779 | $10,103.84 | 86 |
| 6 | $0 | 1.12 | $0.00 | $0.00 | $2,800.00 | $31.11 | $2,644.44 | 20.7% | 21.9% | $12,779 | $10,134.96 | 85 |
| 7 | $0 | 1.12 | $0.00 | $0.00 | $2,800.00 | $31.11 | $2,613.33 | 20.4% | 21.9% | $12,779 | $10,166.07 | 84 |
| 8 | $0 | 1.12 | $0.00 | $0.00 | $2,800.00 | $31.11 | $2,582.22 | 20.2% | 21.9% | $12,779 | $10,197.18 | 83 |
| 9 | $0 | 1.12 | $0.00 | $0.00 | $2,800.00 | $31.11 | $2,551.11 | 20.0% | 21.9% | $12,779 | $10,228.29 | 82 |
| 10 | $5,000 | 1.12 | $600.00 | $5,600.00 | $8,400.00 | $31.11 | $8,120.00 | 63.5% | 21.9% | $12,779 | $4,659.40 | 261 |
| 11 | $0 | 1.12 | $0.00 | $0.00 | $8,400.00 | $90.22 | $8,029.78 | 62.8% | 63.5% | $12,779 | $4,749.62 | 89 |
| 12 | $0 | 1.12 | $0.00 | $0.00 | $8,400.00 | $90.22 | $7,939.56 | 62.1% | 63.5% | $12,779 | $4,839.84 | 88 |
| 13 | $0 | 1.12 | $0.00 | $0.00 | $8,400.00 | $90.22 | $7,849.33 | 61.4% | 63.5% | $12,779 | $4,930.07 | 87 |
| 14 | $0 | 1.12 | $0.00 | $0.00 | $8,400.00 | $90.22 | $7,759.11 | 60.7% | 63.5% | $12,779 | $5,020.29 | 86 |
| 15 | $0 | 1.12 | $0.00 | $0.00 | $8,400.00 | $90.22 | $7,668.89 | 60.0% | 63.5% | $12,779 | $5,110.51 | 85 |
| 16 | $1,500 | 1.12 | $180.00 | $1,680.00 | $10,080.00 | $90.22 | $9,258.67 | 72.4% | 63.5% | $12,779 | $3,520.73 | 103 |
| 17 | $0 | 1.12 | $0.00 | $0.00 | $10,080.00 | $102.87 | $9,155.79 | 71.6% | 72.4% | $12,779 | $3,623.61 | 89 |
| 18 | $0 | 1.12 | $0.00 | $0.00 | $10,080.00 | $102.87 | $9,052.92 | 70.8% | 72.4% | $12,779 | $3,726.48 | 88 |
| 19 | $0 | 1.12 | $0.00 | $0.00 | $10,080.00 | $102.87 | $8,950.04 | 70.0% | 72.4% | $12,779 | $3,829.36 | 87 |
| 20 | $0 | 1.12 | $0.00 | $0.00 | $10,080.00 | $102.87 | $8,847.17 | 69.2% | 72.4% | $12,779 | $3,932.23 | 86 |
| 21 | $0 | 1.12 | $0.00 | $0.00 | $10,080.00 | $102.87 | $8,744.30 | 68.4% | 72.4% | $12,779 | $4,035.10 | 85 |
| 22 | $500 | 1.12 | $60.00 | $560.00 | $10,640.00 | $102.87 | $9,201.42 | 72.0% | 72.4% | $12,779 | $3,577.98 | 89 |
| 23 | $500 | 1.12 | $60.00 | $560.00 | $11,200.00 | $102.24 | $9,659.18 | 75.6% | 72.0% | $12,779 | $3,120.22 | 94 |
| 24 | $0 | 1.12 | $0.00 | $0.00 | $11,200.00 | $107.32 | $9,551.86 | 74.7% | 75.6% | $12,779 | $3,227.54 | 89 |
| 25 | $0 | 1.12 | $0.00 | $0.00 | $11,200.00 | $107.32 | $9,444.54 | 73.9% | 75.6% | $12,779 | $3,334.86 | 88 |
| 26 | $0 | 1.12 | $0.00 | $0.00 | $11,200.00 | $107.32 | $9,337.21 | 73.1% | 75.6% | $12,779 | $3,442.19 | 87 |
| 27 | $0 | 1.12 | $0.00 | $0.00 | $11,200.00 | $107.32 | $9,229.89 | 72.2% | 75.6% | $12,779 | $3,549.51 | 86 |
| 28 | $0 | 1.12 | $0.00 | $0.00 | $11,200.00 | $107.32 | $9,122.56 | 71.4% | 75.6% | $12,779 | $3,656.84 | 85 |
| 29 | $0 | 1.12 | $0.00 | $0.00 | $11,200.00 | $107.32 | $9,015.24 | 70.5% | 75.6% | $12,779 | $3,764.16 | 84 |
| 30 | $0 | 1.12 | $0.00 | $0.00 | $11,200.00 | $107.32 | $8,907.91 | 69.7% | 75.6% | $12,779 | $3,871.49 | 83 |
| | $10,000 | | $1,200 | $11,200 | | $2,292 | | | | | | |

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

A system and method for dynamic working capital have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. A computer-implemented method for providing a dynamic capital line, the method comprising:
calculating a maximum capital line available for a customer;
providing for access by the customer to the maximum capital line; and
providing for micro-repayment of funds received by the customer.

2. The computer-implemented method of claim 1, wherein calculating the maximum capital line available comprises:
receiving data associated with the customer, the data associated with the customer comprising banking/transaction activity data, credit and repayment performance data, behavioral data, and firmographic data;
determining, by using the data associated with the customer, a default value indicating a likelihood of default;
assigning a risk value to the default value;
calculating an exposure value indicating an acceptable level of exposure; and
communicating to the customer the maximum capital line available, the maximum capital line available based on the exposure value.

3. The computer-implemented method of claim 1, wherein providing for access comprises:
receiving a request for capital from the customer, the request for capital comprising an amount of funds;
processing the request for capital upon determining that the amount of funds is within an available amount in the maximum capital line;
transferring the amount of funds to the customer; and
deducting the amount of funds from the maximum capital line value.

4. The computer-implemented method of claim 1, wherein providing for micro-repayment comprises:
obtaining first volume data related to one or more of credit card sales and debit card sales;
obtaining second volume data related to total sales;
determining a split percentage;
determining a repayment amount; and
collecting the repayment amount.

5. The computer-implemented method of claim 2, further comprising:
updating the data associated with the customer according to a predetermined period;
calculating an updated exposure value based on the updated data associated with the customer; and
communicating to the customer an updated maximum capital line available, the updated maximum capital line available based on the updated exposure value.

6. The computer-implemented method of claim 2, wherein the banking/transaction data comprises data related to one or more of a business checking account, a personal checking account, and merchant processing statements.

7. The computer-implemented method of claim 2, wherein the credit and repayment performance data comprises data related to one or more of data received from consumer credit bureaus, data received from business credit bureaus and exchanges, and business performance monitoring tools.

8. The computer-implemented method of claim 2, wherein the firmographic data comprises data related to one or more of purchased data sources and public data sources.

9. The computer-implemented method of claim 2, wherein communicating is performed via one or more of a website, a feed to a mobile device, a voice response unit, and customer service.

10. The computer-implemented method of claim 3, wherein transferring the amount of funds to the customer is completed via one or more of credit card access, ACH transfer, wire transfer, mobile banking transfer, NFC transfer, and online banking transfer.

11. The computer-implemented method of claim 4, wherein collecting the repayment amount is performed via one or more of a split processing collection method, a lockbox collection method, and an ACH collection method.

12. A system for providing a dynamic capital line, the system comprising:
a server, having a processor, in communication with a network; and
software instructions stored on the server and executable by the server, the software instructions for:
calculating a maximum capital line available for a customer;
providing for access by the customer to the maximum capital line; and
providing for micro-repayment of funds received by the customer.

13. The system of claim 12, wherein calculating the maximum capital line available comprises:
receiving data associated with the customer, the data associated with the customer comprising banking/transaction activity data, credit and repayment performance data, behavioral data, and firmographic data;
determining, by using the data associated with the customer, a default value indicating a likelihood of default;
assigning a risk value to the default value;
calculating an exposure value indicating an acceptable level of exposure; and
communicating to the customer the maximum capital line available, the maximum capital line available based on the exposure value.

14. The system of claim 12, wherein providing for access comprises:
receiving a request for capital from the customer, the request for capital comprising an amount of funds;
processing the request for capital upon determining that the amount of funds is within an available amount in the maximum capital line;
transferring the amount of funds to the customer; and
deducting the amount of funds from the maximum capital line value.

15. The system of claim 12, wherein providing for micro-repayment comprises:
obtaining first volume data related to one or more of credit card sales and debit card sales;
obtaining second volume data related to total sales;
determining a split percentage;
determining a repayment amount; and
collecting the repayment amount.

16. The system of claim 13, further comprising:
updating the data associated with the customer according to a predetermined period;
calculating an updated exposure value based on the updated data associated with the customer; and
communicating to the customer an updated maximum capital line available, the updated maximum capital line available based on the updated exposure value.

17. The system of claim 13, wherein the banking/transaction data comprises data related to one or more of a business checking account, a personal checking account, and merchant processing statements.

18. The system of claim 13, wherein the credit and repayment performance data comprises data related to one or more of data received from consumer credit bureaus, data received from business credit bureaus and exchanges, and business performance monitoring tools.

19. The system of claim 13, wherein the firmographic data comprises data related to one or more of purchased data sources and public data sources.

20. The system of claim 13, wherein communicating is performed via one or more of a website, a feed to a mobile device, a voice response unit, and customer service.

21. The system of claim 14, wherein transferring the amount of funds to the customer is completed via one or more of credit card access, ACH transfer, wire transfer, mobile banking transfer, NFC transfer, and online banking transfer.

22. The system of claim 15, wherein collecting the repayment amount is performed via one or more of a split processing collection method, a lockbox collection method, and an ACH collection method.
